(19) United States
(12) Patent Application Publication
(10) Pub. No.: US 2006/0073827 A1
(43) Pub. Date: Apr. 6, 2006

(54) System and handover mechanism in frequency multilple band environment and equipment therefor

(75) Inventors: Ari Vaisanen, Ruutana (FI); Hasse Sinivaara, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION, FIN-02150 Espoo (FI)

(21) Appl. No.: 10/539,704

(22) PCT Filed: Dec. 19, 2002
(86) PCT No.: PCT/IB02/05531

§ 371 Date: Jul. 18, 2005

(51) Int. Cl. H04Q 7/20

(52) U.S. Cl. 455/436

(57) ABSTRACT

A mechanism for supporting the decision on performing a communication connection changeover of a subscriber terminal in a wireless communication network, in particular in a multiple band WLAN, is proposed. The subscriber terminal is a to communicate with an access node on two or more frequency bands. AP related communication information are detected which comprises, besides information indicating a multiple band capability, a traffic load, a frequency band coverage and/or a frequency channel information. The communication information are broadcasted, for example, by means of the AP beacon frame, processed and used for a decision on a communication connection changeover of the subscriber terminal.

### FIELD OF THE INVENTION

The present invention relates to a method and/or a system and/or an access node and/or a subscriber terminal in a wireless communication network in which, at least in part, frequency multi-bands are used for a communication. The present invention relates in particular to a method and/or a system and/or an access node and/or a subscriber terminal used in a decision on performing a communication connection changeover of a subscriber terminal in such a network.

### BACKGROUND OF THE INVENTION

In the last years wireless communication networks, for example for data and/or speech transmissions, became more and more important. One example for such a wireless communication network is a wireless local area network (WLAN) based, for example, on radio frequency transmissions or the like. In such a WLAN, subscriber terminals, such as personal computers, telecommunication equipments, mobile phones, personal digital assistants, laptop computers, personal computers, and the like, are able to perform communications with each other or with corresponding subscriber terminals of other networks (for example wired LANs, WLANs, fixed or mobile telecommunication networks and the like) via corresponding communication protocols. The subscriber terminals are provided with corresponding transmitting and receiving units, such as WLAN PCMCIA cards and the like, via which the subscriber terminal is able to communicate with access nodes or access points (AP) of the WLAN.

The general architecture of a WLAN is commonly known and thus described only shortly. Key elements of a WLAN are the subscriber terminals and access points (AP) with which the subscriber terminal communicates over a wireless communication interface, e.g. radio based. An access point covers a specific area, which is referred to hereinafter as a cell. The size of a cell may vary in dependence of the environment, network operator specifications, number of associated subscribers and the like. The AP is adapted to control communications of the subscriber terminals within this cell, for example, by allocating frequency channels, establishing connections for the subscriber terminals, forwarding data to a destination terminal and the like. A subscriber terminal is normally associated with one access point, which is referred to hereinafter as the serving AP. Furthermore, a distribution network is provided to which the access points are connected. Via the distribution network, communication connections between different APs or external networks (e.g. fixed networks, mobile telecommunications networks such as GSM, UMTS, and the like) can be established for a subscriber terminal.

In case of mobile subscriber terminals there is a situation that a subscriber terminal leaves the cell of its currently serving AP. In this case, roaming or handover is executed. Roaming means that the subscriber terminal searches an available AP whose connection quality is better than a predetermined threshold or the like and switches the connection to this other available AP, which then becomes the new serving AP. The decision whether a roaming is to be executed is based, for example, on signal strength measurements and the like and determined by means of handover algorithms.

WLANs are implemented according to specific standards. One of these standards is, for example, the IEEE (Institute of Electrical and Electronics Engineers) 802.11 standard or its respective extensions (referred to hereinafter also as 802.11 WLAN) such as the IEEE 802.11a, IEEE 802.11b standards, which are commonly known to persons skilled in the art.

In the IEEE 802.11 standards, in particular MAC (MAC: Medium Access Control) and PHY (PHYsical layer) protocols are defined. MAC protocol is used, for example, to allow interoperability between compatible physical layers, to reduce a collision probability between different subscriber terminals, and the like. Moreover, the IEEE 802.11 MAC protocol defines beacon frames sent at regular intervals by the access point to allow stations to monitor the presence of the access point. The IEEE 802.11 MAC protocol also gives a set of management frames including Probe Request frames which are sent by a subscriber terminal and are followed by Probe Response frames sent by an available access point, to allow a subscriber terminal to scan actively if there is an access point operating on a certain channel frequency and to show to the subscriber terminal what parameter settings this access point is using. Additionally, a MAC address is provided which is used as an identification element for the respective WLAN elements.

Recently, the implementation of WLAN structures using frequency multiple bands is planed. One of such structures is, for example, a dual band capability. It is anticipated that the current 802.11b WLAN equipment operating on license free 2.4 GHz ISM (Industrial, Scientific and Medical) frequency band will be complemented with 802.11a WLAN equipment operating in the several license free frequency bands between 5 GHz and 6 GHz. It is also anticipated that most of the new 802.11a WLAN equipment will also comprise 802.11b a 2.4 GHz functionality. These dual band terminals and access points will ensure gradual transition from 802.11b to 802.11a and thus increase the usability and life span of WLAN equipment. One reason for the transition to 802.11a operating on 5 GHz is, for example, that the capacity of the currently used 2.4 GHZ ISM band is to be expanded to build large networks without interference problems. Furthermore, since the frequency range of the 2.4 GHz ISM band is shared with other communication systems such as Blue Tooth, possible interference problems can be prevented. According to the IEEE 802.11 standard on each of the multiple frequency bands a respective beacon frame is to be transmitted by each access point.

It is known that handovers in WLAN are based on WLAN subscriber terminal's decisions. For this purpose, the beacon frames or packets transmitted by the APs at regular intervals are used. As mentioned above one purpose of the beacon packets is to inform the subscriber terminals about AP presence in the area. Furthermore, the subscriber terminals are able to measure RSSI (Received Signal Strength Indicator) for the respective APs. By means of the measured RSSI value the need for a handover to another AP, for example, due to a movement of the subscriber terminal can be judged which is commonly known to person skilled in the art.

As an alternative or supplement to this handover procedure, it is also proposed to transmit traffic load information from the AP to the subscriber terminal which makes the decision on the handover. The load information, also referred to as load bit, is sent, for example, by means of the beacon packets. Thus, the subscriber terminal is able to consider the load situation in the APs during the decision on the handover from the current AP to another AP.

In document EP 1 156 623 A1, a wireless LAN is described in which the roaming procedure is added by a load balancing function. In order to balance the load within the WLAN, the subscriber terminal receives load information concerning the loading status of the access point from access points. Then, the subscriber terminal may select a communication connection with one of the access points by using a cost function in which the received load information is considered.

### SUMMARY OF THE INVENTION

It is an object of the present invention to provide an improved mechanism to decide whether or not a communication connection changeover or handover of a subscriber terminal is to be performed in a wireless communication network, for example, of a WLAN type in which frequency multi-bands are usable for the communication.

Furthermore, it is an object of the present invention to provide an improved method and/or system and/or access node and/or subscriber terminal by means of which an improved handover decision can be made in a wireless communication network, for example, of a frequency multi-band WLAN type.

These objects are achieved, for example, by a method of deciding on performing a communication connection changeover of a subscriber terminal in a wireless communication network comprising at least one access node, wherein said subscriber terminal is able to communicate with an access node in said wireless communication network on two or more frequency bands, said method comprising the steps of detecting and transmitting communication information from said at least one access node to said subscriber terminal, said communication information comprising information indicating whether the transmitting access node is capable to communicate on two or more frequency bands, processing the transmitted communication information and determining a communication connection capability of the transmitting access node on the basis of the frequency band information, and using the processing result for a decision on a communication connection changeover of the subscriber terminal.

Furthermore, these objects are achieved, for example, by a system for deciding on performing a communication connection changeover of a subscriber terminal in a wireless communication network comprising at least one access node, wherein said subscriber terminal is able to communicate with an access node in said wireless communication network on two or more frequency bands, said system comprising means for detecting and transmitting communication information from said at least one access node to said subscriber terminal, said communication information comprising information indicating whether the transmitting access node is capable to communicate on two or more frequency bands, means for processing the transmitted communication information so as to determine a communication connection capability of the transmitting access node on the basis of the frequency band information, and means for deciding on a communication connection changeover of the subscriber terminal by using the processing result.

Moreover, these object are achieved, for example, by an access node in a wireless communication network, said access node communicating with at least one subscriber terminal wherein said subscriber terminal is able to communicate with the access node on two or more frequency bands, said access node comprising means for detecting and transmitting communication information to said subscriber terminal, said communication information comprising information indicating whether the access node is capable to communicate on two or more frequency bands.

Furthermore, these objects are achieved, for example, by a subscriber terminal communicating in a wireless communication network comprising at least one access node, wherein said subscriber terminal is able to communicate with an access node in said wireless communication network on two or more frequency bands, said subscriber terminal comprising means for receiving communication information transmitted from at least one access node, said communication information comprising information indicating whether the transmitting access node is capable to communicate on two or more frequency bands, means for processing the transmitted communication information so as to determine a communication connection capability of the transmitting access node on the basis of the frequency band information, and means for deciding on a communication connection changeover of the subscriber terminal by using the processing result.

According to one aspect, the wireless communication network in which the proposed method and/or system and/or access node and/or subscriber terminal are implemented is a WLAN. The WLAN may be preferably based on IEEE 802.11 standards, such as IEEE 802.11a, 802.11b and the like. In such a case the used two or more frequency bands may comprise a frequency band of 2.4 GHz (according to IEEE 802.11b) and one or more frequency bands between 5 and 6 GHz (according to IEEE 802.11a).

Further Refinements of the Proposed Solutions Are As Set Out Below:

The communication information may be broadcasted from the access node or nodes to subscriber terminals in the respective coverage area by means of the beacon frame. That means that the communication information can be incorporated in a beacon packet. However, the proposed solution is not necessarily limited to the usage of the beacon frame. Alternatively, also another suitable signaling and/or communication between the access node or nodes and the subscriber terminal can be used for the transmission of the communication information. For example, Probe Request/Probe Response can be used. Basically, load information can be asked by the subscriber terminal through Probe Request. The AP sends the corresponding information in the Probe Response. Additionally, these Probes can be utilized for carrying various parameters and information between subscriber terminals and APs.

The information element or elements in the communication information may comprise a multiple band indicator indicating which frequency band/bands the transmitting access node offers. When the transmitting access node has, for example, a dual band capability, a dual (i.e. multiple) band information element such as a dual band bit is set. In case the transmitting access node has a triple (or even more) band capability, a corresponding multiple band information element is set.

Additionally, the information element or elements in the communication information may comprise a traffic load indicator related to the transmitting access node. That means that the access node may detect the traffic load on its frequency band/bands and determine a corresponding value for the traffic load information element to be set. One traffic load information element per used frequency band of the transmitting access node is preferably set which may have different values corresponding to the respective traffic situation on this frequency band.

Alternatively or additionally to the traffic load information element, the information element or elements in the communication information may comprise a frequency band coverage indicator. This coverage information element may include an indication about the communication capability of neighboring access nodes of the transmitting access node in the wireless communication network. This means that the coverage information element may be used, for example, to inform about the availability of continuing a communication with a neighboring access node on a frequency band currently usable at the present access node.

Alternatively or additionally to the traffic load information element and/or the coverage information element, the information element or elements in the communication information may comprise a frequency channel indicator for indicating the frequency channel used by the access node at the respective frequency band. That means that this channel information element may indicate which actual channel is used by the access node on the frequency bands. For example, in case of an access node having a dual band capability the channel in use at the other frequency band different to the frequency band currently used can be indicated.

Optionally, in addition to the processing of the information element or elements, a signal strength indicator measured on a predetermined frequency band may be compared with a predefined threshold value for determining the communication connection capability of the transmitting access node on another frequency band. By measuring and comparing the signal strength indicator of a predetermined (lower) frequency band, an estimation on the communication connection quality on a specific (higher) frequency band of the same AP is possible which in turn indicates whether a communication connection on the other (higher) band would have a sufficient or insufficient connection quality.

The decision on a communication connection changeover may be made on the subscriber terminal side. The received communication information transmitted by the access node is used by the subscriber terminal as a basis for this decision.

A result of the decision on a communication connection changeover of the subscriber terminal may be to change (i.e. handover) the communication connection from the present frequency band to another frequency band which is common to the subscriber terminal and the access node associated with the subscriber terminal. This means that it is known that both the subscriber terminal and the access node can communicate on a frequency band different to the frequency band currently in use. Thus, a handover from the current frequency band to the second frequency band (in case of a dual band situation) in the same access node is possible.

Furthermore, a result of the decision on a communication connection changeover of the subscriber terminal may be to change the communication connection from the current access node to a specific frequency band of a neighboring access node which is common to the subscriber terminal and the neighboring access node to be associated with the subscriber terminal. This means that it is known which frequency bands are common to the subscriber terminal and a neighboring access node. Thus, a handover to a predetermined frequency band at a neighboring access node in the wireless communication network is possible.

It is possible to receive and process communication information which is transmitted from two or more access node in the wireless communication network. This means that communication information from several (all) access points in range are used for the decision on a communication connection changeover. In other words, multiple band information elements and traffic load information elements and/or coverage information elements and/or the channel information element from more than one access node may be considered in the handover decision.

By Virtue of the Present Solutions, the Following Advantages Can Be Achieved:

When there are multiple band access points (AP) and multiple band subscriber terminals in the wireless communication network, such as a WLAN, it is possible to divide traffic between the multiple frequency bands evenly. For example, in case of a dual band WLAN situation, a 5 GHz band may be used always when it is available and feasible. By providing information about the dual band capability of equipment, e.g., by the beacon frame broadcasted by the APs the subscriber terminal can be immediately informed about the possibility to use, for example, 2.4 GHz or 5 GHz frequency band for a communication. Thus, it can be avoided to scan through both bands and all frequencies by the subscriber terminal to detect the dual band capability. This saves time and battery power.

The transmitted communication information from the APs can be used to support a communication connection changeover decision unit, for example in the subscriber terminal, to make improved handover decisions. When it is known that the currently connected AP has dual band functionality, for example by setting the dual (multiple) band information element, a handover from, e.g., the current 2.4 GHz band to the 5 GHz band is possible while remaining at the coverage area of this AP. This is advantageous to balance the traffic load at the serving AP.

By including the traffic load information element in the communication information it is possible to inform about the current load of the AP. This may include information concerning the load on the currently used frequency band and/or on the frequency band/bands currently not used by the subscriber terminal. This improves the “intelligence” of the handover decision. For example, in case the traffic load of a dual band AP is high on one of the frequency bands, a handover to this frequency band would not be useful. By providing information on the load situation on the frequency bands an unnecessary handover to a loaded frequency band, which would result in a return to the original frequency band, can be avoided. Thus, time and battery power can be saved.

By including the coverage information element in the communication information it is possible to inform about the continuation or discontinuation of availability of one or more of the frequency bands which are currently available in the cell of a neighboring AP. For example, in the case of a moving subscriber terminal, information on the coverage information element can be used to decide whether a handover should take place on 5 GHz band or 2.4 GHz band should be used to establish a connection to a new AP. In the case of a subscriber terminal crossing the border between a serving dual band AP and an AP having only a single band capability, it is possible to inform the subscriber terminal that a handover to the only frequency band of the new AP is to be performed which may be different to the currently used frequency band. Thus, an unnecessary searching at the currently used frequency band in the new AP cell can be avoided. This saves time and battery power. Additionally, the coverage information element is useful in a situation where the communication connection with the serving access node is lost and past information about other access nodes recognized by the subscriber terminal are not useful. Then, the subscriber terminal can recognize by means of the coverage information element that the communication connection on the current frequency band may continue, i.e. that only a temporary loss of coverage on the band in use has occurred. Thus, the subscriber terminal can directly start scanning for a new (neighboring) access node on the correct frequency band. Therefore, it is possible to avoid frequency scanning on incorrect frequency bands before a correct frequency band. In the case of larger network consisting of both dual band and single band APs, the subscriber terminal can thus be informed it is operating in an area having a sufficient coverage on one, both or more frequency bands. By avoiding unnecessary scanning on incorrect frequency bands of (neighboring) access nodes, time and battery power can be saved.

By including the channel information element in the communication information it is possible to inform about the channel in use at the other band/bands in the AP. In the case of changeover of the communication connection between frequency bands, it is possible to directly set the correct frequency at the new frequency band. The channel information element may indicate the channel of frequency bands of the current AP and/or of frequency bands of neighboring APs. Thus time and battery power can be saved.

By using the measurement of the received signal strength indicator (RSSI) on a predetermined frequency band it is possible to evaluate whether a changeover from the current frequency band (for example, 2.4 GHz) to another frequency band (for example, 5 GHz) at the same AP is useful or not. The signal strength received by the subscriber terminal, e.g., from a dual band AP at 5 GHz band is typically lower than signal strength received at 2.4 GHz band from the same AP. The reason is that higher propagation losses are suffered at the higher frequency band. By means of a specific threshold value (which might be different to the threshold used in the normal handover procedure) which is to be compared with the RSSI being measured by the subscriber terminal on the 2.4 GHZ band the signal strength on the higher 5 GHz band can be estimated. Thus, it is possible to estimate the RSSI value on the higher frequency band by means of measurements on the lower frequency band and without the need for changing the connection to the higher band. If the lower band RSSI value is higher than the threshold value, the signal strength of the higher frequency band is estimated to be sufficient, and a handover or changeover to the 5 GHz band is useful. On the other hand, if the lower band RSSI is lower than the specific threshold value it is likely that an efficient communication cannot be established on the higher frequency band. Thus, an unnecessary handover to a frequency band not providing sufficient communication quality is avoided, so that time and battery power can be saved.

By using a suitable signaling or communication path, such as the beacon frame, for broadcasting the communication information and by introducing the respective information element or elements, for example, in the beacon packet, e.g. by means of respective information bits, the proposed solutions are easy to implement in the present wireless communication networks such as the WLAN. The information element or elements may be carried in the beacon frame, for example, by present spare bits of beacon packets. Thus, backward compatibility is ensured.

In the communication connection changeover decision unit, for example on the subscriber terminal side, the used handover algorithms can easily be expanded to take into account the transmitted communication information from the AP in the handover decision. Since handover algorithms are in general provider specific, it is possible to select those information elements (or single element) which are (is) suitable for the respective network equipment, the environmental situation, and the like.

The communication information may comprise all of the above described information elements (also referred to as a full setup), or alternatively, only a subset of the above described information elements, if suitable. A selection of respective information elements (or single element) for such a subset can be provider specific, environment specific (dependent, for example, on neighboring access node situation), equipment specific (dependent, for example, on communication capabilities of the transmitting access node), situation specific (dependent, for example, on actual traffic load at the transmitting access node), and the like.

The above and still further objects, features and advantages of the invention will become more apparent upon referring to the description and the accompanying drawings.

### BRIEF DESCRIPTION OF THE DRAWINGS

FIG. 1 shows a wireless communication network of a WLAN type.

FIG. 2 shows a diagram for illustrating communication information transmission between a subscriber terminal and access points in the wireless communication network according to FIG. 1.

FIG. 3 shows a flow chart describing a communication connection changeover method.

### DESCRIPTION OF PREFERRED EMBODIMENTS

A preferred embodiment of the invention is presented herein below in connection with the description of the figures.

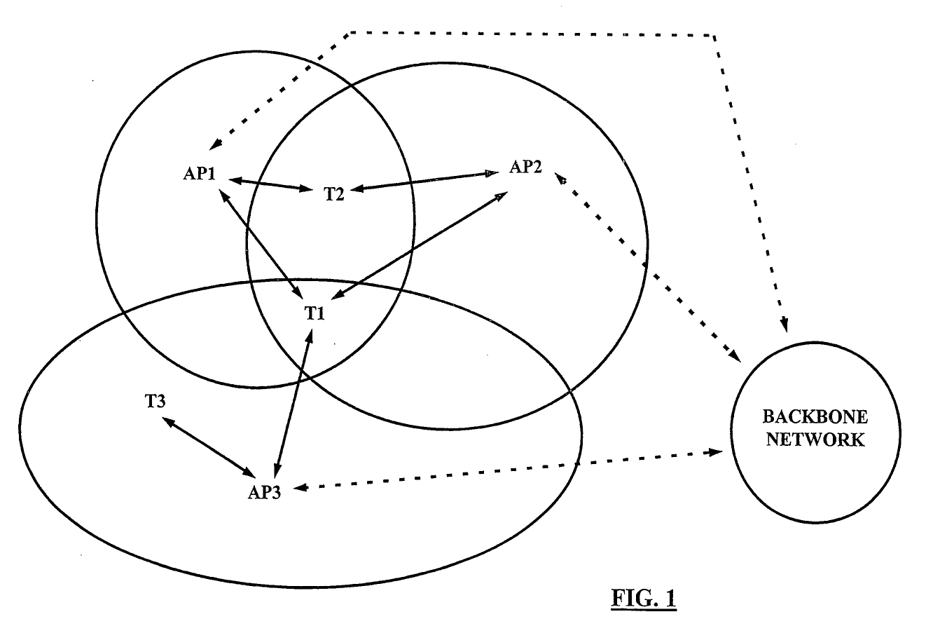

Referring to FIG. 1, a WLAN according to IEEE 802.11 standards as a wireless communication network is schematically shown. The WLAN comprises several access points AP1, AP2, AP3 as communication control elements. Furthermore, in the example shown, a backbone network is provided which serves as a distribution network for connecting the APs to one another and to external destination points such as other WLANs or fixed networks. For connecting the APs to the backbone network, commonly known input/output (I/O) interfaces (not shown) are used. At least some of the APs are able to communicate on different frequency bands, i.e. they have a frequency multi-band capability. In the following it is assumed that these APs are so-called dual band APs communicating on a 2.4 GHz ISM band and a 5 GHz ISM band. However, the proposed solution is also applicable to APs providing more than two frequency bands, for example, triple band APs or the like. In such a case the proposed solution is to be adapted accordingly, i.e. the measures to be effected in connection with two frequency bands are to be effected in connection with the respective number of other frequency bands. The same is applies for the subscriber terminals. At least some of the shown subscriber terminals are adapted to communicate on more than one frequency band. Again, it is assumed that these subscriber terminals so-called dual band subscriber terminals communicating on the 2.4 GHz ISM band and the 5 GHz ISM band.

Each of the APs defines a cell of a specific size (indicated by the circles surrounding the APs). Subscriber terminals T1, T2, T2 within the network may be associated (connected) with one AP (serving AP) in whose cell they are located. In the present example, as the starting situation, subscriber terminal T1 is associated with AP1, T2 is associated with AP2, and T3 is associated with AP3.

Irrespective of its specific type (e.g. personal computer, laptop, mobile phone and the like) a subscriber terminal comprises several means (not shown) which are required for its communication functionality and which are known to those skilled in the art. Such means are for example a processor for executing instructions and processing data for the communication connection (e.g. transmission content and signaling related data), memory means for storing instructions and data, for serving as a work area of the processor and the like (e.g. ROM, RAM, EEPROM, and the like), input means for inputting data and instructions by software (e.g. floppy disk, CD-ROM, EEPROM, and the like), user interface means for providing monitor and manipulation possibilities to a user (e.g. a screen, a keyboard, a microphone and headset for communication, and the like), and network interface means for establishing a communication connection under the control of the processor (e.g. and wireless interface means, receiving and transmitting means, an antenna, and the like). These means can be integrated within one device (e.g. in case of a mobile telephone) or in several devices forming the subscriber terminal (e.g. in case of a personal computer). The network interface means may be included, for example, in a WLAN PCMCIA card.

Similarly, an access point comprises several means (not shown) which are required for its communication functionality and which are known to those skilled in the art. Such means are for example a processor for executing instructions and processing data for the communication connection (e.g. transmission forwarding and signaling related data), memory means for storing instructions and data, for serving as a work area of the processor and the like (e.g. ROM, RAM, EEPROM, and the like), input means for inputting data and instructions by software (e.g. floppy disk, CD-ROM, EEPROM, and the like), user interface means for providing monitor and manipulation possibilities to a user (e.g. a screen, a keyboard, and the like), network interface means for establishing a communication connection with subscriber terminals under the control of the processor (e.g. and wireless interface means, receiving and transmitting means, an antenna, and the like), distribution network interface means for communicating via the backbone network with other APs under the control of the processor, and the like. Besides a dedicated communication connection with an associated subscriber terminal, the AP is adapted to transmit or broadcast signaling data within its cell, which enables to determine connection quality information related to this AP. This may be performed by means of a beacon frame, which is sent permanently or in specific intervals.

Dual band equipment, i.e. dual band APs and dual band subscriber terminals, comprise respective receiving and transmitting means (RX, TX) for communication on each of the available frequency bands. These receiving and transmitting means can be separate elements in the network interface means or integrated in one unit. Dual band APs broadcast a beacon frame on each of their frequency bands. On the other hand, dual band subscriber terminals are adapted to receive the beacon frame on each of their frequency bands.

In the WLAN depicted in FIG. 1, a subscriber terminal receives signaling data (beacon frame or packet) from those APs in whose cells it is located. This means, T1 receives signaling data from AP1, AP2, AP3, T2 receives signaling data from AP1, AP2, and T3 receives signaling data from AP3. On the other hand, the subscriber terminal sends data to its respective serving AP. The signaling data, from which, for example, the RSSI is derived, may be used to determine the connection quality situation for the subscriber terminal, i.e. whether there is an AP other than the current serving AP, which provides a better communication situation. In such a case, the subscriber terminal may initialize a handover procedure in order to associate with the other AP, as known in the prior art and described, for example, in connection with the standards of wireless communication networks.

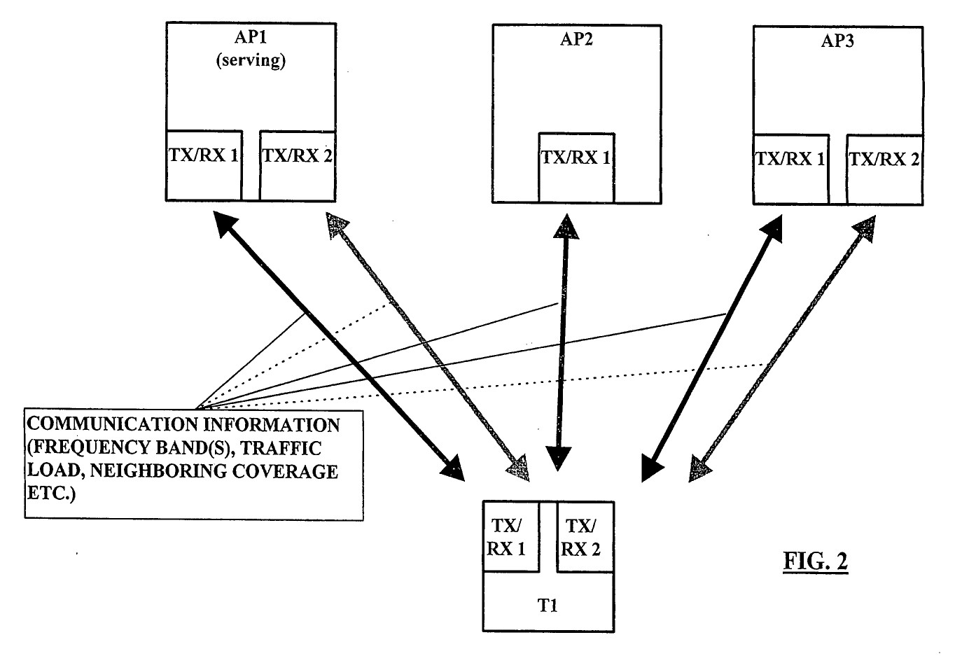

When dual band equipment is used in the WLAN, this “normal” handover procedure can be improved. Referring to FIG. 2, a more detailed illustration of parts of the WLAN according to FIG. 1 is shown.

According to FIG. 2, the WLAN comprises two dual band APs (AP1, AP3). In the present example, it is assumed that AP2 is a single band AP. The dual band APs each comprise two transmitting and receiving units TX/RX for communicating with subscriber terminals in the respective cell. TX/RX1 is used to communicate on a first frequency band, for example, of 2.4 GHz, and TX/RX2 is used to communicate on a second frequency band, for example, of 5 GHz. AP2 comprise only one TX/RX unit capable to communicate on the 2.4 GHz band.

For the sake of simplicity only one subscriber terminal T1 is shown. However, additional subscriber terminals can be connected to respective APs, and the proposed measures described below for these subscriber terminals and APs are equivalent. In the shown case, the subscriber terminal T1 is a dual band subscriber terminal comprising two transmitting and receiving units TX/RX for communicating with AP. Equivalent to the transmitting and receiving units of the APs, TX/RX1 is used to communicate on a first frequency band of 2.4 GHz, and TX/RX2 is used to communicate on a second frequency band of 5 GHz.

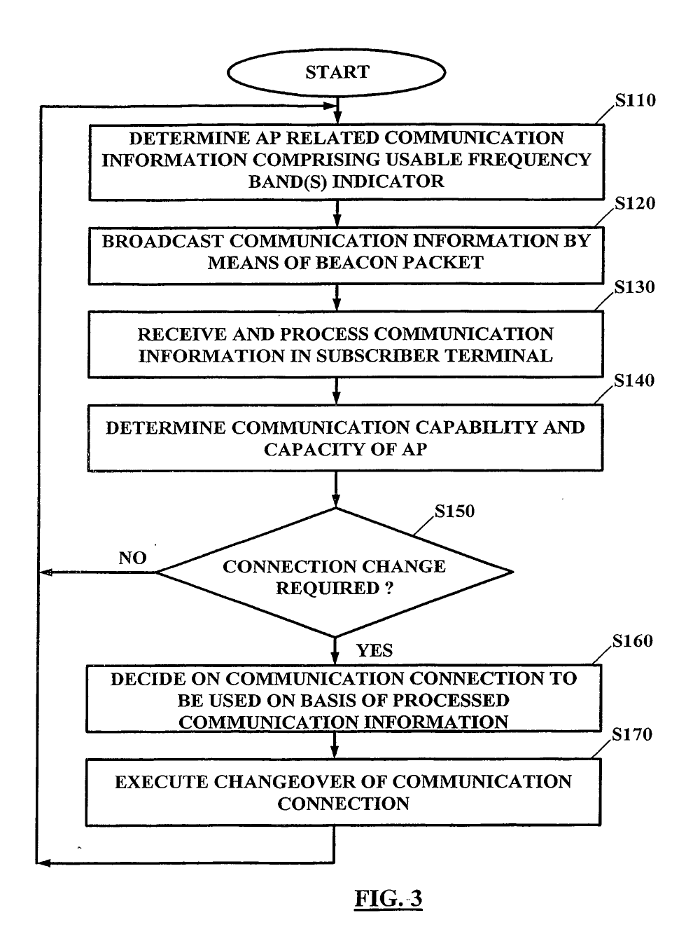

Now, referring to FIGS. 2 and 3, an example for the proposed communication connection changeover mechanism is described.

The access nodes AP1, AP2 and AP3 comprises means (not shown) which determine communication information related to this AP (step S110 in FIG. 3). This communication information comprises an indication whether the AP is a multiple band, i.e. in the present example a dual band AP. This dual (multiple) band information may also indicate the specific frequency band or bands used by the AP.

Besides the multiple band information, the APs may also be adapted to determine further information which can be used in the communication information.

One example is to determine the current traffic load on the respective channels. This means, for example, that the AP detects the data amount flowing on each channel and derives a corresponding indication value informing about a low load, a medium load, a high load, and the like. The classification of the load value indicator can have different forms and may be provider specific or standardized. When the traffic load is determined, a corresponding indicator can be included in the communication information for the respective frequency channels.

Furthermore, a coverage information can be determined by the AP. For this purpose, for example, a stored table or list can be referred to in which the frequency bands used by neighboring APs are stored. When a neighboring AP provides the same frequency bands as the present AP, these APs can be indicated by an corresponding identifier (e.g. MAC address) in the communication information. Otherwise, APs providing different or less frequency bands can be indicated in a similar manner. In addition, an indication which specific frequency band or bands (for example 2.4 GHz and/or 5 GHz) are provided by the respective neighboring AP can also be included in this information element.

Moreover, a channel information can be determined by the AP. This means that the AP determine which frequency channel on the respective frequency bands is used and includes a corresponding indicator in the communication information. In the case that the coverage information is provided this channel information may be expanded to inform about the channels used by the neighboring APs on the respective frequency bands.

Dependent, for example, on settings by the network provider or operator, the communication information may comprise different combination of the information elements or indicators described above, i.e. a full setup or a suitable subset thereof. Preferably, the communication information comprises the multiple band information element and respective traffic load information elements. Alternatively, the traffic load information elements are added or substituted by the coverage information elements and/or the channel information element. A pre-selection of respective information elements for such a subset can be based, for example, on one or more of the following:

provider specification, where the network provider decides which information elements are to be used;

environment specific, where, for example, the coverage information element is omitted when no neighboring access nodes or only access nodes with the same frequency bands are present;

situation specific, where, for example, the traffic load information is omitted when the actual traffic load at the transmitting AP is such that enough capacity can be guaranteed.

The determined communication information, i.e. the information elements to be determined according to the settings in the AP, is included by the AP in the beacon packet which is, for example, intermittently broadcasted on the frequency bands provided by the AP (step S120 in FIG. 3). According to FIG. 2, the access nodes AP1 and AP3 broadcast the beacon packets via each of the transmitting and receiving units TX/RX1 and TX/RX2. AP2 has only one frequency band and broadcast a corresponding beacon frame via its transmitting and receiving unit TX/RX1. Alternatively to the beacon frame, another suitable signaling or communication between the AP and the subscriber terminal may be used, such as Probe Request/Probe Response.

Here, in case of the dual band APs AP1 and AP3, a separation of useful information for the respective frequency band can be performed, for example, by the processing means of the AP. This separation means that, for example, the beacon packet or frame broadcasted on the first frequency band may include the multiple band information elements related to the second frequency band, traffic load information elements for the first and second frequency bands, channel information elements for the second frequency band. On the other hand the beacon packet broadcasted on the second frequency band may include the multiple band information elements related to the first frequency band, traffic load information elements for the first and second frequency bands, channel information elements for the first frequency band. Coverage information elements can be the same for both beacon packets of the AP. This example describes the case where the full setup is included. However, also only a subset of information elements can be made available in the beacons of the first and second (or more) frequency band.

The subscriber terminal T1 which is located in the cell areas of all three APs receives at least those beacon packets which are broadcasted on the frequency band currently used (i.e. set) in the subscriber terminal T1 (step S130 in FIG. 3), for example, by the transmitting and receiving unit TX/RX1. The subscriber terminal processes the received beacon packets, for example by its processing means, and detects the communication information included therein. In the present example, the processing includes all beacon packet information received, i.e. of AP1, AP2 and AP3. Alternatively, the subscriber terminal may use a filter function to process only the communication information transmitted by the serving AP1.

Now, the communication information are used by the subscriber terminal T1 to determine the communication capability of the respective AP (step S140 in FIG. 3). This means that the information elements of the communication information included in the beacon packet are considered. When the multiple band information element is included, the subscriber terminal T1 recognizes the other frequency band provided by the AP and compares it with its frequency bands. When the information matches a handover to the other frequency band is possible. When traffic load information elements are included, the corresponding values are determined. When the load value of the other frequency band provided by the AP indicates a lower traffic load, a handover to this frequency band may be useful. Additionally, the traffic load on the currently used frequency band is recognized. When the coverage information element is included frequency bands and identifiers of neighboring access nodes are recognized. When the channel information element is included, the used frequency channel of the other possible frequency band is recognized for a using in a possible handover situation.

Optionally, in addition to the processing and usage of the information elements for the determination of the communication capability of the respective AP, in the processing of step 140, the RSSI value measured on the lower (e.g., 2.4 GHz) frequency band can be used for a comparison with a predefined threshold value. The result of the comparison is usable for an estimation of the communication connection capability of the same AP on a higher (e.g. 5 GHz) frequency band. Thus, an indication on whether a communication connection changeover to the higher frequency band is useful or not can be derived. This can be used by the subscriber terminal for a decision in a handover procedure.

The recognized information and results can be stored in the subscriber terminal for a subsequent usage (not shown), for example, in a memory of the subscriber terminal. When a next beacon packet is received and processed, then stored information is updated. The same applies for new RSSI comparisons. In case that communication information from several APs are processed, the respective information are related to these APs, for example, by means of the AP identifier.

Next it is decided whether or not a communication connection changeover (i.e. a handover) is necessary (step S150 in FIG. 3). When the subscriber terminal detects a situation which requires a connection changeover, the decision is YES. On the other hand, when no need for a handover is detected (NO in step S150), the next beacon packet, i.e. the next communication information, is awaited. Such a handover situation may occur, for example, when connection quality is detected to be not sufficient or the received signal strength (RSSI measurement) is not sufficient. Also, when a load balancing function is implemented, a changeover may be required when the traffic load on the used frequency band is high. This decision is based, for example, on handover algorithms executed by the processing means of the subscriber terminal. The used type of handover algorithm (i.e. the used parameters such as thresholds for signal strength, load value and the like) can be provider specific.

When a communication connection changeover is decided, in step S160 of FIG. 3, the communication connection changeover decision unit in the subscriber terminal T1 refers to the information stored in reaction to the processing of the communication information. This means that for the decision to which new communication connection is to be changed the above described multiple band information, respective traffic load information, coverage information, and/or channel information element can be used, if available. Also the result of the comparison of the lower frequency band's RSSI value with the predefined threshold can be considered in the decision. As a possible example, when the other frequency band of the AP has a low traffic load in comparison to the currently used frequency band, the communication connection can be changed to the other frequency band. When both frequency bands of the current AP have a high traffic load, the communication connection should not be changed to the other band but instead to another AP. In such a case coverage information are useful to decide which AP and which respective frequency band is usable. The coverage information are also usable in the case that the subscriber terminal T1 moves and is now located in the cell of another AP, for example AP3 in FIG. 2. Then the coverage information indicate the dual band capability of AP2 so that the communication on the same both frequency bands could be continued. On the other hand, when the subscriber terminal T1 moves to AP2, which is a single band equipment, the subscriber terminal knows that the communication connection is to be established on the only frequency band. Furthermore, when the communication connection with the serving AP is lost and past information about other access nodes recognized by the subscriber terminal are not useful, the subscriber terminal can use the coverage information element to directly start scanning for a new (neighboring) access node on the correct frequency band. This means, the subscriber terminal can recognize by means of the coverage information element whether the communication connection on the current frequency band may continue, i.e. that only a temporary loss of coverage on the band in use has occurred, or also the frequency band has to be changed. In the case of larger network consisting of both dual band and single band APs, the subscriber terminal can thus recognize that it is operating in an area having a sufficient coverage on one, both or more frequency bands. On the other hand, when the connection is to be changed to the other frequency band of the current AP, the channel information can be used to directly go to the actual frequency channel of this frequency band. However, when the communication connection is presently on the lower frequency band and the measured RSSI value is lower than the predefined threshold value it is assumed that the connection quality at the higher frequency band of the same AP is also not sufficient, and a changeover to this higher frequency band is not performed. Instead, the decision may be to change the connection to another AP.

For the decision to which communication connection is to be changed handover algorithms can be used which are expanded to take into account the available information elements from the AP. The calculation of this handover algorithm is performed by the processing means of the subscriber terminal T1, for example. As a result thereof, the best candidate for the new communication connection of the subscriber terminal T1, either a new frequency band of the same AP or a frequency band of another (neighboring) AP is determined.

When the target (other frequency band or other AP) of the changeover of the communication connection of the subscriber terminal T1 is determined, in step S170 of FIG. 3, the subscriber terminal T1 performs the handover to this target according to handover procedures commonly known. When the handover is complete, handling of now received communication information is repeated.

Thus, it is possible to decide on a communication connection changeover of a subscriber terminal, in particular in a frequency multi-band environment, on the basis of a plurality of information provided by the WLAN APs. Hence, an optimized handover decision is possible while an unnecessary waste of time and battery power on the subscriber terminal side due to an unnecessary scanning on frequency bands is avoided. Furthermore, by introducing traffic load information, a load balancing between multiple frequency bands is possible.

As described above there is proposed a mechanism for supporting the decision on performing a communication connection changeover of a subscriber terminal in a wireless communication network, in particular in a multiple band WLAN. The subscriber terminal is able to communicate with an access node on two or more frequency bands. AP related communication information are detected which comprises, besides information indicating a multiple band capability, a traffic load, a frequency band coverage and/or a frequency channel information. The communication information are broadcasted, for example, by means of the AP beacon frame, processed and used for a decision on a communication connection changeover of the subscriber terminal.

It should be understood that the above description and accompanying figures are merely intended to illustrate the present invention by way of example only. The described embodiments of the present invention may thus vary within the scope of the attached claims.

1. Method of deciding on performing a communication connection changeover of a subscriber terminal (T1) in a wireless communication network comprising at least one access node (AP1, AP2, AP3), wherein said subscriber terminal is able to communicate with an access node in said wireless communication network,
said method comprising the steps of:
detecting communication information from said at least one access node, said communication information comprising frequency band information indicating at least one frequency band where said at least one access node is capable to communicate;
transmitting said communication information from said at least one access node to said subscriber terminal by signaling;
processing the transmitted communication information and determining based on the communication information a communication connection capability of at least part of the at least one access node on the basis of the frequency band information; and
using the processing result for a decision on a communication connection changeover of the subscriber terminal.

2. Method according to claim 1, wherein said wireless communication network is a WLAN, preferably based on an IEEE 802.11 standard.

3. Method according to claim 2, wherein said at least one frequency band comprise a frequency band of 2.4 GHz and one or more frequency bands between 5 and 6 GHz.

4. Method according to claim 1, wherein said communication information further comprises a multiple band indicator related to at least part of the at least one access node.

5. Method according to claim 1, wherein said communication information further comprises a traffic load indicator related to the at least one frequency band of at least part of the at least one access node.

6. Method according to claim 1, wherein said communication information further comprises a frequency band coverage indicator related to frequency bands of neighboring access nodes of the transmitting access node in the wireless communication network.

7. Method according to claim 1, wherein said information in said communication information comprise a frequency channel indicator for indicating the frequency channel used by at least part of the at least one access node at the respective frequency band.

8. Method according to claim 1, wherein said processing step further comprises steps of
detecting a signal strength indicator on a predetermined frequency band; and
comparing the detected signal strength indicator with a predefined threshold value, wherein the result of the comparison indicates an estimation of the connection capability of an access node on another frequency band.

9. Method according to claim 1, wherein the decision on a communication connection changeover is made by the subscriber terminal.

10. Method according to claim 1, wherein a result of the decision on a communication connection changeover of the subscriber terminal is a change of the communication connection from the present frequency band to another frequency band which is common to the subscriber terminal and the access node associated with the subscriber terminal.

11. Method according to claim 1, wherein a result of the decision on a communication connection changeover of the subscriber terminal is a change of the communication connection from the current access node to a specific frequency band of a neighboring access node which is common to the subscriber terminal and the neighboring access node to be associated with the subscriber terminal.

12. Method according to claim 1, wherein communication information transmitted from two or more access nodes in the wireless communication network are processed in said processing step.

13. System for deciding on performing a communication connection changeover of a subscriber terminal (T1) in a wireless communication network comprising at least one access node (AP1, AP2, AP3), wherein said subscriber terminal is able to communicate with at least one access node in said wireless communication network,
said system comprising:
means for detecting and transmitting communication information from said at least one access node to said subscriber terminal, said communication information comprising frequency band information indicating at least one frequency band where said at least one access node is capable to communicate, wherein said means for detecting and transmitting the communication information of the at least one access node are adapted to incorporate the communication information in a signaling to said subscriber terminal;
means for processing the transmitted communication information so as to determine based on the communication information a communication connection capability of at least part of the at least one access node on the basis of the frequency band information; and
means for deciding on a communication connection changeover of the subscriber terminal by using the processing result.

14. System according to claim 13, wherein said wireless communication network is a WLAN, preferably based on an IEEE 802.11 standard.

15. System according to claim 14, wherein said at least one frequency band comprises a frequency band of 2.4 GHz and one or more frequency bands between 5 and 6 GHz.

16. System according to claim 13, wherein said communication information further comprises a multiple band indicator related to at least part of the at least one access node.

17. System according to claim 13, wherein said communication information further comprises a traffic load indicator related to the at least one frequency band of at least part of the at least one access node.

18. System according to claim 13, wherein said communication information further comprises a frequency band coverage indicator related to frequency bands of neighboring access nodes of the at least one access node in the wireless communication network.

19. System according to claim 13, wherein said communication information further comprises a frequency channel indicator for indicating the frequency channel used by the access node at the respective frequency band.

20. System according to claim 13, further comprising means for detecting a signal strength indicator on a predetermined frequency band; wherein said means for processing are adapted to compare the detected signal strength indicator with a predefined threshold value, the result of the comparison indicating an estimation of the connection capability of an access node on another frequency band, and said means for deciding on a communication connection changeover are adapted use the result of said comparison.

21. System according to claim 13, wherein the means for deciding on a communication connection changeover is located in the subscriber terminal.

22. System according to claim 13, wherein the means for deciding on a communication connection changeover are adapted to decide to change the communication connection from the present frequency band to another frequency band which is common to the subscriber terminal and the access node associated with the subscriber terminal.

23. System according to claim 13, wherein the means for deciding on a communication connection changeover are adapted to decide to change the communication connection from the current access node to a specific frequency band of a neighboring access node which is common to the subscriber terminal and the neighboring access node to be associated with the subscriber terminal.

24. System according to claim 13, wherein the means for processing the transmitted communication information are adapted to process communication information transmitted from two or more access nodes in the wireless communication network.

25. Access node for a wireless communication network said access node comprising:
means for detecting and transmitting communication information to said subscriber terminal, said communication information comprising frequency band information indicating at least one frequency band where at least one access node is capable to communicate, wherein said means for detecting and transmitting the communication information are adapted to incorporate the communication information in a signaling to said subscriber terminal.

26. Access node according to claim 25, wherein said wireless communication network is a WLAN, preferably based on an IEEE 802.11 standard.

27. Access node according to claim 26, wherein said at least one frequency band comprise a frequency band of 2.4 GHz and one or more frequency bands between 5 and 6 GHz.

28. Access node according to claim 25, wherein said communication information further comprises a multiple band indicator related to an access node.

29. Access node according to claim 25, wherein said communication information further comprises a traffic load indicator related to the at least one frequency band of an access node.

30. Access node according to claim 25, wherein said communication information further comprises a frequency band coverage indicator related to frequency bands of neighboring access nodes of the access node in the wireless communication network.

31. Access node according to claim 25, wherein said communication information further comprises a frequency channel indicator for indicating the frequency channel used by the access node at the respective frequency band.

32. Subscriber terminal for communicating in a wireless communication network comprising at least one access node (AP1, AP2, AP3),
said subscriber terminal comprising:
means for receiving communication information transmitted from at least one access node, said communication information comprising frequency band information indicating at least one frequency band where at least one access node is capable to communicate, and being transmitted from said at least one access node to said subscriber terminal by signaling;
means for processing the transmitted communication information so as to determine based on the communication information a communication connection capability of at least part of the at least one access node on the basis of the frequency band information; and
means for deciding on a communication connection changeover of the subscriber terminal by using the processing result.

33. Subscriber terminal according to claim 32, wherein said wireless communication network is a WLAN, preferably based on an IEEE 802.11 standard.

34. Subscriber terminal according to claim 33, wherein said at least one frequency band comprises a frequency band of 2.4 GHz and one or more frequency bands between 5 and 6 GHz.

35. Subscriber terminal according to claim 32, wherein said means for receiving the communication information of the access node are adapted to extract the communication information from a beacon packet broadcasted from the access node.

36. Subscriber terminal according to claim 32, wherein said communication information further comprises a multiple band indicator related to at least part of the at least one access node.

37. Subscriber terminal according to claim 32, wherein said communication information further comprises a traffic load indicator related to the at least one frequency band of at least part of the at least one transmitting access node.

38. Subscriber terminal according to claim 32, wherein said communication information further comprises a frequency band coverage indicator related to frequency bands of neighboring access nodes of the transmitting access node in the wireless communication network.

39. Subscriber terminal according to claim 32, wherein said communication information further comprises a frequency channel indicator for indicating the frequency channel used by the access node at the respective frequency band.

40. Subscriber terminal according to claim 32, further comprising means for detecting a signal strength indicator on a predetermined frequency band; wherein said means for processing are adapted to compare the detected signal strength indicator with a predefined threshold value, the result of the comparison indicating an estimation of the connection capability of an access node on another frequency band, and said means for deciding on a communication connection changeover are adapted use the result of said comparison.

41. Subscriber terminal according to claim 32, wherein the means for deciding on a communication connection changeover are adapted to decide to change the communication connection from the present frequency band to another frequency band which is common to the subscriber terminal and the access node associated with the subscriber terminal.

42. Subscriber terminal according to claim 32, wherein the means for deciding on a communication connection changeover are adapted to decide to change the communication connection from the current access node to a specific frequency band of a neighboring access node which is common to the subscriber terminal and the neighboring access node to be associated with the subscriber terminal.

43. Subscriber terminal according to claim 32, wherein the means for processing the transmitted communication information are adapted to process communication information transmitted from two or more access node in the wireless communication network.

44. A computer program product for a computer, comprising software code portions for making, when said product is run on the computer, said computer to function as an access node in a wireless communication network,
said computer program product is configured to work as:
means for detecting and transmitting communication information to said subscriber terminal, said communication information comprising frequency band information indicating at least one frequency band where at least on access node is capable to communicate, wherein said means for detecting and transmitting the communication information are adapted to incorporate the communication information in a signaling to said subscriber terminal.

45. A computer program product for a computer, comprising software code portions for making, when said product is run on the computer, said computer to function as a subscriber terminal communicating in a wireless communication network comprising at least one access node,
said computer program product is configured to work as:
means for receiving communication information transmitted from at least one access node, said communication information comprising frequency band information indicating at least one frequency band where at least one access node is capable to communicate, and being transmitted from at least one access node to said subscriber terminal by signaling;
means for processing the transmitted communication information so as to determine based on the communication information a communication connection capability of at least part of the at least one access node on the basis of the frequency band information; and
means for deciding on a communication connection changeover of the subscriber terminal by using the processing result.

46. A computer program product according to claim 44, wherein said computer program product comprises a computer-readable medium on which said software code portions are stored.

47. A computer program product according to claim 44, wherein said computer program product is directly loadable into the internal memory of the computer.

48. Method usable in an access node entity for a decision procedure on performing a communication connection changeover of a subscriber terminal in a wireless communication network comprising at least one access node, wherein said subscriber terminal is able to communicate with an access node in said wireless communication network,
said method comprising the steps of:
detecting communication information from said at least one access node, said communication information comprising frequency band information indicating at least one frequency band where said at least one access node is capable to communicate;
transmitting said communication information from said at least one access node to said subscriber terminal by signaling.

49. Method usable in a subscriber terminal entity for a decision procedure on of deciding on performing a communication connection changeover of a subscriber terminal in a wireless communication network comprising at least one access node, wherein said subscriber terminal is able to communicate with an access node in said wireless communication network,
said method comprising the steps of:
receiving communication information from said at least one access node, said communication information comprising frequency band information indicating at least one frequency band where at least one access node is capable to communicate, by signaling;
processing the transmitted communication information and determining based on the communication information a communication connection capability of at least part of the at least one access node on the basis of the frequency band information; and
using the processing result for a decision on a communication connection changeover of the subscriber terminal.

50. The method according to claim 1, wherein the signaling by means of which the communication information is transmitted comprises a transmission of one or more frames.

51. The method according to claim 1, wherein the signaling by means of which the communication information is transmitted comprises a Probe Request/Probe Response.

52. The method according to claim 4, wherein the multiple band indicator indicates at least one frequency band.

53. The system according to claim 13, wherein the signaling by means of which the communication information is transmitted comprises a transmission of one or more frames.

54. The system according to claim 13, wherein the signaling by means of which the communication information is transmitted comprises a Probe Request/Probe Response.

55. The system according to claim 16, wherein the multiple band indicator indicates at least one frequency band.

56. The access node according to claim 25, wherein the signaling by means of which the communication information is transmitted comprises a transmission of one or more frames.

57. The access node according to claim 25, wherein the signaling by means of which the communication information is transmitted comprises a Probe Request/Probe Response.

58. The access node according to claim 28, wherein the multiple band indicator indicates at least one frequency band.

59. The subscriber terminal according to claim 32, wherein the signaling by means of which the communication information is received comprises a transmission of one or more frames.

60. The subscriber terminal according to claim 32, wherein the signaling by means of which the communication information is received comprises a Probe Request/Probe Response.

61. The subscriber terminal according to claim 36, wherein the multiple band indicator indicates at least one frequency band.

62. A computer program product according to claim 45, wherein said computer program product comprises a computer-readable medium on which said software code portions are stored.

63. A computer program product according to claim 45, wherein said computer program product is directly loadable into the internal memory of the computer.
